(19) United States
(12) Patent Application Publication
(10) Pub. No.: US 2015/0076864 A1
(43) Pub. Date: Mar. 19, 2015

(54) Door Intrusion Resistance Apparatus for a Vehicle

(71) Applicant: Ford Global Technologies, LLC, Dearborn, MI (US)

(72) Inventors: Mohammed Omar Faruque, Ann Arbor, MI (US); Michael M. Azzouz, Livonia, MI (US)

(73) Assignee: Ford Global Technologies, LLC, Dearborn, MI (US)

(21) Appl. No.: 14/027,564

(22) Filed: Sep. 16, 2013

(51) Int. Cl. B60J 5/04

(52) U.S. Cl. CPC B60J 5/0458
USPC 296/187.12

(57) ABSTRACT

A vehicle body and a door intrusion resistance apparatus for a vehicle with a door that includes a protrusion and a rocker defining a receptacle that receives the protrusion when the door is closed. The door is inhibited from moving above the rocker by the protrusion being received in the receptacle that holds the door against the rocker in a side impact collision.

### TECHNICAL FIELD

The present disclosure relates to safety features for vehicles, and in particular features that mitigate body side intrusions in side impact collisions.

### BACKGROUND

A vehicle door may consist of an outer panel facing the exterior of the vehicle and an inner panel facing the cabin of the vehicle. The inner panel includes a lower wall that faces a rocker assembly. In a side impact collision, vehicle doors may collapse inwardly and intrude into the cabin of the vehicle. Excessive door intrusion may adversely affect deployment of a side air bag due to the reduced gap between the door and the occupant.

Some safety structures may attempt to minimize the door intrusion into the cabin from a side impact collision. Such a structure is disclosed in U.S. Pat. No. 4,462,633. U.S. Pat. No. 4,462,633 discloses a box shaped reinforcing member mounted on a vehicle floor that extends above the side sill or rocker panel. A bracket mounted to the door has a portion engaging the reinforcing member when the door is closed. In a side impact collision, the bracket engages the reinforcing member to inhibit inward movement of the door. The box shaped reinforcing member is visible to an occupant, especially when the door is open. An occupant must step over the rocker panel when entering or exiting the vehicle. A box shaped reinforcing member that is disposed above the rocker panel interferes with the ingress and egress of the occupant. Placing a box shaped reinforcing member above the rocker panel also limits design freedom. The receiver must be of a limited size to reduce interference with the ingress and egress of the occupant.

The above problems and other problems are addressed by this disclosure as summarized below.

### SUMMARY

One aspect of the present disclosure relates to an apparatus for resisting intrusion of a door into a passenger compartment of a vehicle that has a rocker. The apparatus includes a projection extending horizontally from the door and a catcher that is provided on the rocker. The rocker includes a vertically extending wall. When the door is closed, the catcher receives a portion of the projection to hold the door in engagement with the vertically extending wall of the rocker.

Other aspects of the above apparatus include a reinforcement panel attached to an inner side of an inner panel of the door for supporting the projection. A grommet may be attached to the vertically extending wall of the rocker. The grommet surrounds the catcher and defines a slit extending substantially throughout a length of the catcher. The slit receives the projection when the door is closed. The rocker may include a rocker reinforcement panel attached to the rocker to reinforce the rocker about the catcher.

The projection of the apparatus may be a loop that includes two legs that are each attached to the reinforcement panel by its respective foot. The door may include an inner panel, and the projection may include a first leg and a second leg extending horizontally and inwardly from the inner panel of the door. The projection also includes a cross-piece connecting a distal end of the first leg to a distal end of the second leg. The reinforcement panel of the apparatus may be attached to the inner panel, wherein the first leg and the second leg are attached to the reinforcement panel at their ends that are opposite their distal ends to support the projection.

Another aspect of the present disclosure relates to a vehicle body that includes a rocker and a door connected to the vehicle body above the rocker. The door is moveable between an open position and a closed position. The door includes an outer panel and an inner panel attached to the outer panel. The inner panel includes a rocker engaging portion that faces the rocker when the door is in the closed position and a projection attached to the rocker engaging portion. The projection protrudes from the rocker engaging portion. The rocker defines a catcher opening that receives the projection when the door is closed to inhibit the door from moving inboard in a side impact collision.

The inner panel of the vehicle body may include a door trim portion disposed above the rocker engaging portion. The projection of the vehicle body may be a U-shaped member, a loop, or it may include a first leg extending from the inner panel portion and a second leg also extending from the inner panel portion. The projection may also include a cross-piece perpendicularly attached to the first leg and the second leg.

The vehicle body may also include a reinforcement panel attached to the inner panel. The vehicle body may further include a reinforcement panel attached to the rocker and disposed on the rocker at an area where the catcher is formed. The vehicle body may also include a floor side inner attached to the vehicle body. The floor side inner and the rocker form a catcher cavity. When the door is closed, a portion of the projection is positioned within the catcher cavity.

Yet another aspect of the present disclosure relates to a door intrusion resistance apparatus for a vehicle that includes a door including a protrusion and a rocker defining a receptacle that receives the protrusion when the door is closed. In a side impact collision with the door, the door is inhibited from moving above the rocker by the protrusion being received in the receptacle to hold the door against the rocker.

The protrusion of the door intrusion resistance apparatus may extend horizontally from an inner panel of the door inboard of the vehicle. The protrusion is also positioned below a door trim so that when the door is closed, the protrusion is not visible to an occupant. The rocker of the door intrusion resistance apparatus may also include a wall that extends in a vertical direction. The wall defines the receptacle that receives the protrusion when the door is closed.

### BRIEF DESCRIPTION OF THE DRAWINGS

FIG. 1 is a perspective view of a vehicle incorporating a door intrusion resistance apparatus of the present disclosure.

FIG. 2A is a partial perspective view of a lower inner portion of a front door illustrating a projection.

FIG. 2B is a close up view of FIG. 2A showing how the projection extends through the inner door.

FIG. 3A is a partial perspective view of the opposite side of the lower inner portion of FIG. 2A illustrating a reinforcement panel attached to the lower inner portion.

FIG. 3B is a close up view of FIG. 3A illustrating the legs of the projection with feet that anchor the projection to the door.

FIG. 4 is a partial side elevation view of the rocker panel illustrating the catcher provided on the rocker.

FIG. 5 is a cross-sectional view of the rocker panel taken along the lines 5-5 in FIG. 4.

FIG. 6 is a partial perspective view of the rocker panel illustrating the catcher provided on the rocker and the grommet covering the catcher.

FIG. 7 is a partial perspective view of the rocker panel of FIG. 6 with the projection engaging the catcher.

FIG. 8 is a cross-sectional view taken along the line 8-8 in FIG. 1 showing the door intrusion resistance apparatus.

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

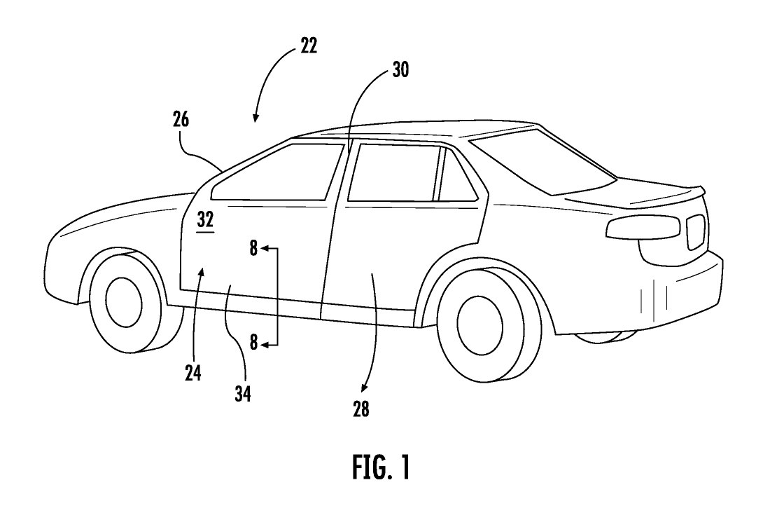

Referring to FIG. 1, a vehicle 22 incorporating the door intrusion resistance apparatus includes a front door 24 attached to a vehicle body adjacent to the A-pillar 26. The vehicle 22 also includes a rear door 28 attached to the vehicle body near the B-pillar 30. Door 24 includes an upper outer portion 32 and a lower outer portion 34. The door intrusion resistance apparatus may be incorporated with any of the doors of the vehicle 22.

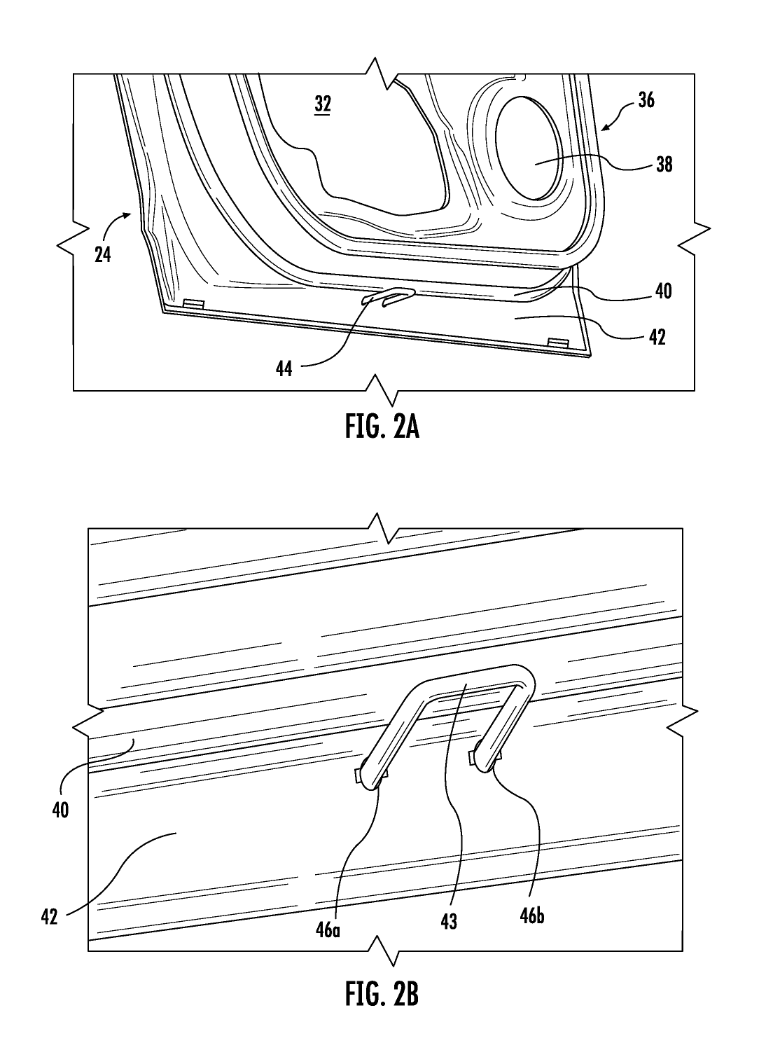

Referring to FIG. 2A, door 24 includes an upper inner portion 36 and an upper outer portion 32. In between the upper inner portion 36 and the upper outer portion 32 is a cavity 38 where vehicle accessories may be mounted, such as those for opening and closing the doors and windows, for defrosting the windows, and audio speakers. The accessories may be covered by a door trim or an interior trim panel that may be another inboard side panel mounted to the upper inner portion. Door 24 also includes a lower inner portion 42 disposed below the upper inner portion 36. The upper inner portion 36 may have an overhang or an offset surface from the lower inner portion 42 to encapsulate the accessories within the cavity formed by the upper inner portion 36 and the upper outer portion 32. A door seal 40 is attached between the upper inner portion and the lower inner portion. When the door 24 is in a closed position, the lower inner 42 is not visible to an occupant of the vehicle.

The door intrusion resistance apparatus includes a projection 44 connected to the lower inner portion 42 and extends or protrudes substantially horizontally from the lower inner portion 42. Thus, the term “protrusion” may also sometimes be used to refer to the projection 44. The projection 44 may be disposed at a slight angle relative to the lower inner portion 42. The projection 44 is positioned below the door seal 40 and is in a form of a loop or a U-shaped member. Projection 44 includes a pair of parallel legs 46a and 46b that extend through the lower inner 42, and a cross-piece 43 is attached to the distal ends of the legs 46a and 46b (FIG. 2B).

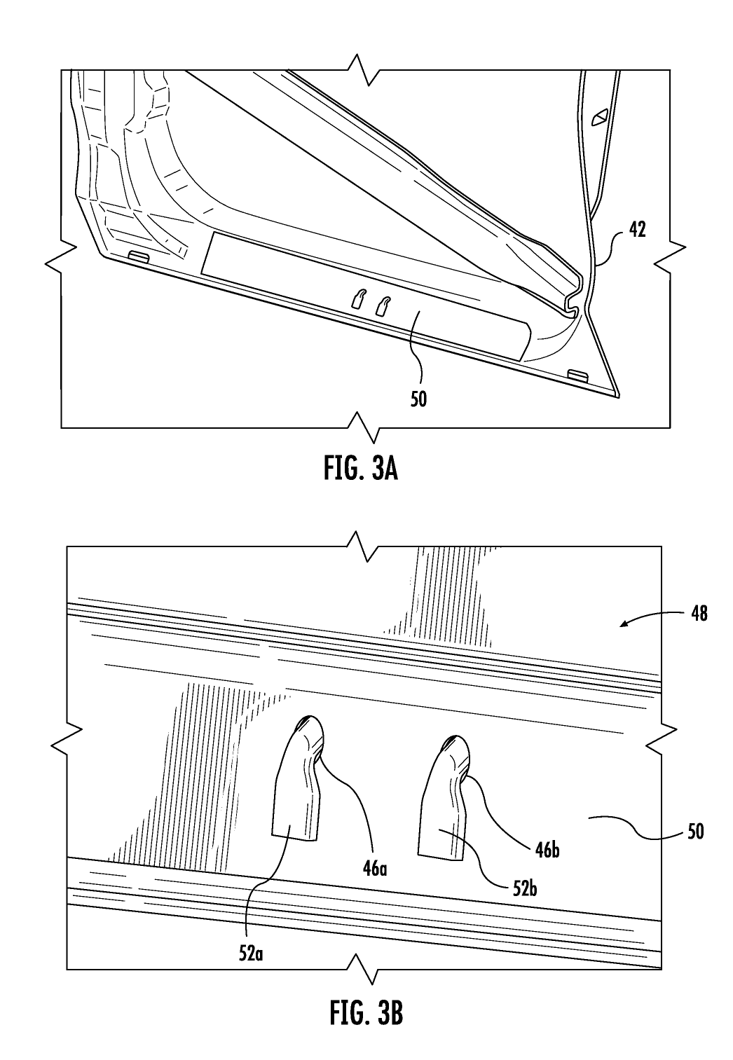

Legs 46a and 46b extend through holes that are formed on the lower inner portion 42 and on a reinforcement panel 50 attached to the lower inner 42 (FIG. 3A). The reinforcement panel 50 may be made of steel and adds supporting structure that provides rigidity to the lower inner portion so that the projection 44 is not easily detached from the lower inner portion. In addition, the reinforcement panel 50 is adapted to resist crumpling of the lower inner portion in a side impact collision. Referring to FIG. 3B, a first foot 52a is preferably connected to leg 46a, and a second foot 52b is connected to leg 46b. The first foot 52a and the second foot 52b are substantially perpendicularly connected to their respective legs. The first foot 52a and the second foot 52b abut the door reinforcement panel 50 to attach and secure the projection 44 to the lower door panel. The feet may also be flattened at their ends to enhance the attachment of the projection 44 to the lower door panel. The projection 44 is attached to the lower inner portion 42 and is not visible to an occupant of the vehicle when the door 24 is closed. This location of the projection 44 provides flexibility in designing and determining the size of the projection 44 because it does not negatively impact the appearance of the door.

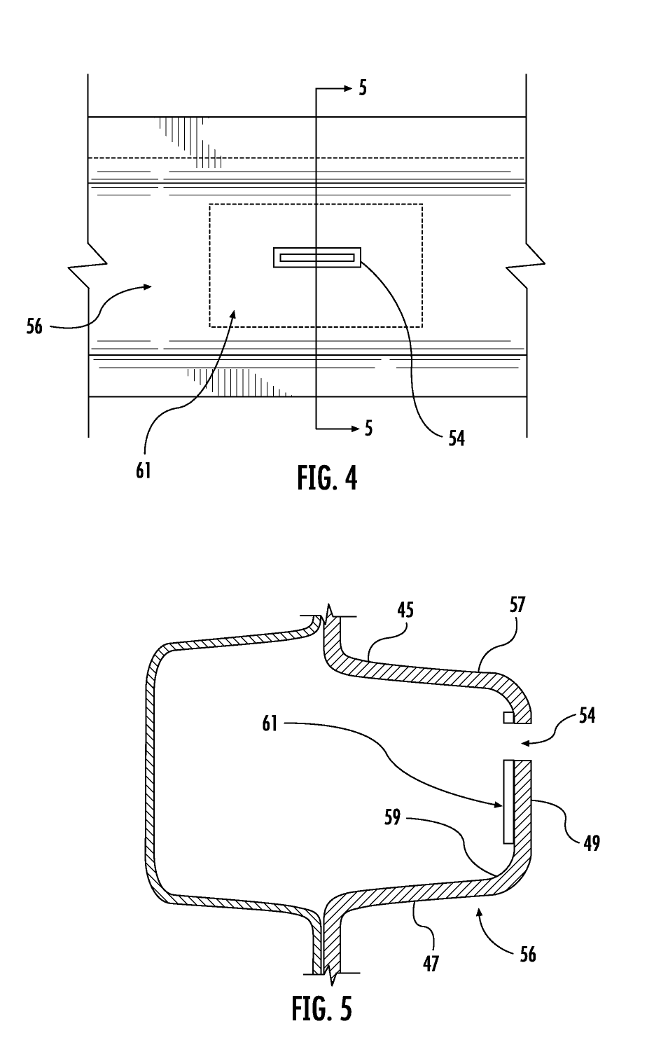

The term “rocker assembly” may be interchanged with the term “rocker” to refer to a portion of the body paneling of a vehicle that is situated below the doorsills of the vehicle. Referring to FIGS. 4-5, a rocker assembly 56 includes an outer wall 57. The outer wall 57 includes a top wall 45, a bottom wall 47 that is positioned below the top wall 45, and a vertically extending wall 49 connected to the top wall 45 and the bottom wall 47. The top wall 45 may provide a door threshold for the vehicle and may be substantially horizontal. In certain embodiments, it is parallel with a vehicle floor. The bottom wall 47 serves as the base of the vehicle body and is a part of the periphery of the vehicle body. The vertically extending wall 49 contacts the lower inner portion 42 of the door 24 when the door is in a closed position.

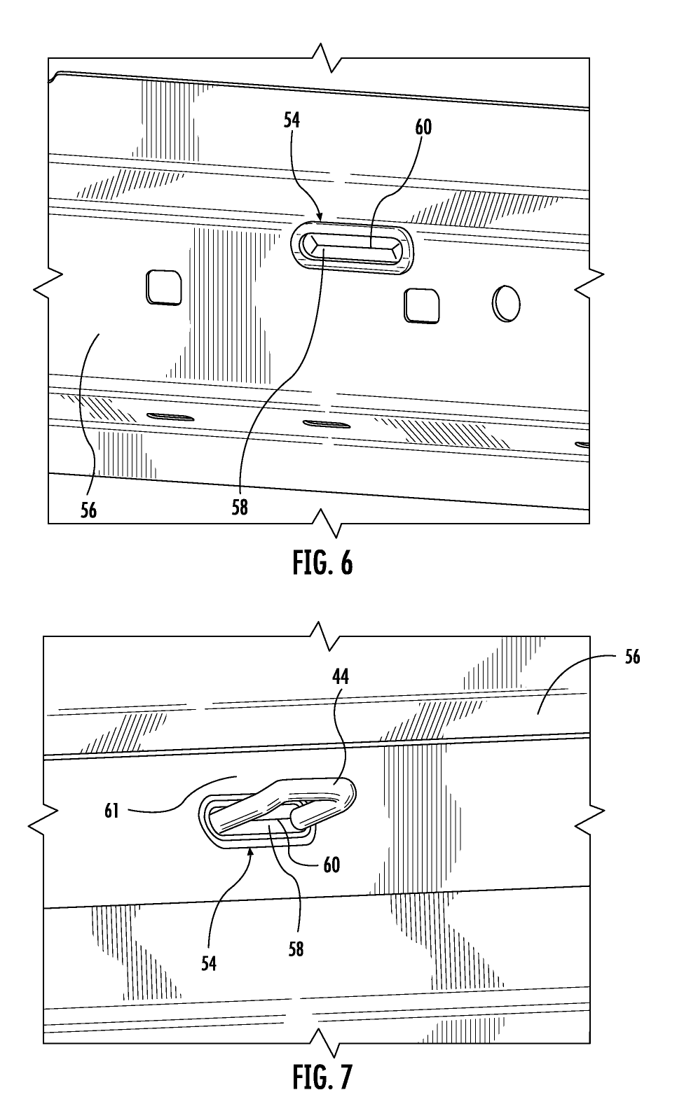

The rocker assembly 56 also includes an inner wall 59 opposite the outer wall 57. The rocker assembly 56 includes a door reinforcement panel 61 attached to the inner wall 59. The door reinforcement panel 61 may be made of steel. The door intrusion resistance apparatus of the present disclosure includes a catcher 54 that is formed as an opening on the rocker assembly 56 and a reinforcement panel 61 attached to the inner wall 59 of the rocker assembly 56. More specifically, the catcher 54 is formed on the vertically extending wall 49 of the rocker assembly 56. The catcher 54 is shaped to receive the projection 44. For instance, the catcher 54 may be elliptical in shape and may have a semi-major axis diameter that is larger than the width of the cross-piece 43 of the projection 44. The catcher 54 may also be a rectangular opening that has a length that is larger than the width of the cross-piece 43 of the projection 44. Referring to FIG. 6, a grommet 58, such as those made of rubber material, may be positioned around the opening of the catcher 54 to seal the catcher and minimize water intrusion to the catcher 54. The grommet 58 includes a slit 60 extending substantially throughout the length of the catcher 54 to receive the projection 44. The slit 60 may be single-lined slit across the middle of the catcher that diverges into a V-shaped slit at both ends. In FIG. 7, when the door is closed, a portion of the projection 44 is inserted through the slit 60 of the grommet 58, the catcher 54, and the reinforcement panel 61 that is attached to the inner wall 59 of the rocker assembly 56.

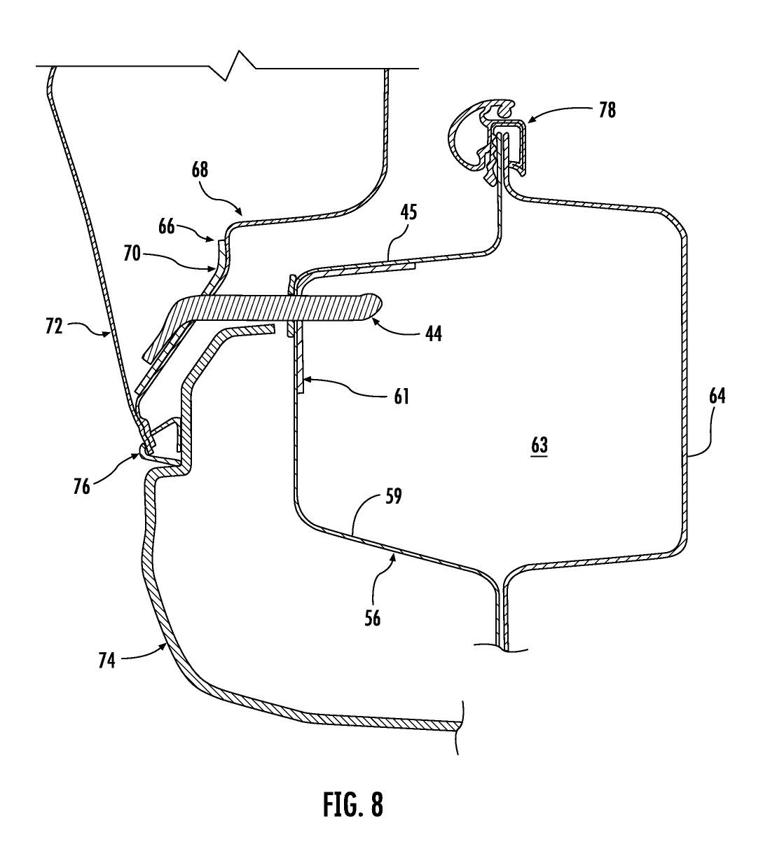

Referring to FIG. 8, looking from the rocker assembly, a portion of the projection 44 is preferably received in a cavity 63 that is formed by the rocker assembly 56 and a floor side inner portion 64 of a vehicle. The rocker assembly 56 includes an inner wall 59 where the reinforcement panel 61 is attached. The reinforcement panel 61 may be attached to an area of the inner wall 59 that defines the catcher 54. Looking from the lower inner portion 66, the projection 44 of the door intrusion resistance apparatus of the present disclosure is attached to an inner panel of the door, and more specifically the lower inner portion 66 that is below the upper inner portion 68. Thus, the lower inner portion 66 serves as a rocker engaging portion that faces the rocker. When the door is in a closed position, the upper inner portion 68 is disposed on top of the rocker assembly 56, more specifically the top wall 45 of the rocker assembly. The upper inner portion 68 may contact a primary door seal 78 that is attached at the boundary of the rocker assembly 56 and the floor side inner portion 64. The lower inner portion 66 is enforced by an inner reinforcement panel 70 attached to an area of the lower inner portion where the projection 44 is attached. As further shown in FIG. 5, the projection 44 is attached to the inner panel portion, which is opposite to the outer panel portion 72. The lower inner portion 66 where the projection 44 is attached is above a rocker molding 74, and a secondary door seal 76 may be provided at the boundary of the lower inner portion 66 and the rocker molding 74. A portion of the projection is received in the catcher and is positioned within the catcher cavity defined by the rocker assembly and the floor inner portion when the door is closed. Movement of the door towards the cabin of the vehicle (door intrusion) is inhibited or at least minimized in a side impact collision because the projection and the catcher hold the door in engagement with the rocker assembly.

A door intrusion resistance apparatus is provided that is discreetly positioned on a door of a vehicle that does not adversely impact the appearance of the door. The door intrusion resistance apparatus does not adversely impact ingress and the egress of vehicle occupants. The door intrusion resistance apparatus utilizes a catcher defined by an opening in the rocker assembly for receiving the projection. No hooks, boxes, or structures protrude from the rocker assembly that can impact the ingress and egress of the vehicle users.

While exemplary embodiments are described above, it is not intended that these embodiments describe all possible forms of the disclosed apparatus and method. Rather, the words used in the specification are words of description rather than limitation, and it is understood that various changes may be made without departing from the spirit and scope of the disclosure as claimed. The features of various implementing embodiments may be combined to form further embodiments of the disclosed concepts.

What is claimed is:

1. An apparatus for resisting intrusion of a door into a passenger compartment of a vehicle having a rocker , the apparatus comprising:
a projection extending horizontally from the door; and
a catcher provided on the rocker, wherein the rocker includes a vertically extending wall, wherein when the door is closed the catcher receives a portion of the projection to hold the door in engagement with the vertically extending wall of the rocker.

2. The apparatus of claim 1, further comprising a reinforcement panel attached to an inner side of an inner panel of the door for supporting the projection.

3. The apparatus of claim 2, wherein the projection is a loop that includes two legs that are each attached to the reinforcement panel by a foot that is attached to the reinforcement panel.

4. The apparatus of claim 1, wherein the door includes an inner panel and the projection includes a first leg and a second leg extending horizontally and inwardly from the inner panel of the door, a cross-piece connecting a distal end of the first leg to a distal end of the second leg.

5. The apparatus of claim 4, further comprising a reinforcement panel attached to the inner panel, wherein the first leg and the second leg are attached to the reinforcement panel at their ends that are opposite their distal ends to support the projection.

6. The apparatus of claim 1, further comprising a grommet attached to the vertically extending wall of the rocker that defines an opening in the catcher, the grommet surrounds the catcher and defines a slit extending substantially throughout a length of the catcher, wherein the slit being receives the projection when the door is closed.

7. The apparatus of claim 1, further comprising a rocker reinforcement panel attached to the rocker to reinforce the rocker about the catcher.

8. A vehicle body comprising:
a rocker;
a door connected to the vehicle body above the rocker, the door being moveable between an open position and a closed position, the door including an outer panel and an inner panel attached to the outer panel, the inner panel including a rocker engaging portion that faces the rocker when the door is in the closed position; and
a projection attached to the rocker engaging portion and protruding from the rocker engaging portion; wherein the rocker defines a catcher opening that receives the projection when the door is closed to inhibit the door from moving inboard in a side impact collision.

9. The vehicle body of claim 8 wherein the inner panel includes a door trim portion disposed above the rocker engaging portion.

10. The vehicle body of claim 8 wherein the projection is a U-shaped member.

11. The vehicle body of claim 8 wherein the projection is a loop.

12. The vehicle body of claim 8 wherein the projection includes a first leg extending from the inner panel portion and a second leg also extending from the inner panel portion.

13. The vehicle body of claim 12 wherein the projection includes a cross-piece perpendicularly attached to the first leg and the second leg.

14. The vehicle body of claim 8 further comprising a reinforcement panel attached to the inner panel.

15. The vehicle body of claim 8 further comprising a reinforcement panel attached to the rocker and disposed on the rocker at an area where the catcher is formed.

16. The vehicle body of claim 8 further comprising a floor side inner attached to the vehicle body, the floor side inner and the rocker forming a catcher cavity, wherein when the door is closed, a portion of the projection is positioned within the catcher cavity.

17. A door intrusion resistance apparatus for a vehicle comprising:
a door including a protrusion; and
a rocker defining a receptacle that receives the protrusion when the door is closed, wherein in a side impact collision with the door the door is inhibited from moving above the rocker by the protrusion being received in the receptacle to hold the door against the rocker.

18. The door intrusion resistance apparatus of claim 17, wherein the protrusion extends horizontally from an inner panel of the door inboard of the vehicle, the protrusion being positioned below a door trim so that when the door is closed, the protrusion is not visible to an occupant.

19. The door intrusion resistance apparatus of claim 17, wherein the rocker includes a wall that extends in a vertical direction, wherein the wall defines the receptacle.
